(19) United States
(12) Patent Application Publication
(10) Pub. No.: US 2002/0088701 A1
(43) Pub. Date: Jul. 11, 2002

(54) Heat integrated distillation

(76) Inventor: James N. Sorensen, Calgary (CA)

Correspondence Address: BIRCH STEWART KOLASCH & BIRCH, PO BOX 747, FALLS CHURCH, VA, 22040-0747, US

(21) Appl. No.: 09/757,848

(22) Filed: Jan. 10, 2001

(51) Int. Cl. B01D 3/32

(52) U.S. Cl. 202/153; 202/154; 202/155; 202/158; 202/172; 202/173; 202/186; 203/71; 203/87; 261/DIG. 72

(57) ABSTRACT

A heat integrated distillation column provides heat at each theoretical stage of distillation in a heating portion and coolant at each theoretical stage of distillation in a cooling portion.

### FIELD AND BACKGROUND OF THE INVENTION

The present invention relates generally to the field of distillation and in particular to a new and useful distillation apparatus and process which integrates reboiler heat and reflux coolant to provide more efficient distillation.

Process distillation columns currently have external heat exchangers to supply heat to the bottom portion of the column. The heat exchangers typically consist of a bottom reboiler and/or one or more side reboilers. Heat supply sources can be steam, hot oil or process heat from other parts of the same processing unit. Process distillation columns also have external overhead condensers to provide reflux to the column. Coolant for the external overhead condensers can be air, cooling water, refrigerant or process coolant from another part of the same processing unit.

### SUMMARY OF THE INVENTION

It is an object of the present invention to provide a process distillation column having integrated heating and cooling to improve the efficiency of the column by reducing the amount of energy required to operate the column.

Accordingly, a process distillation column is provided having integrated reboiler heat at each theoretical distillation stage and integrated reflux coolant at each theoretical distillation stage in the upper portion of the column where cooling is needed. The heated portion of the distillation column has a plurality of heating cores arranged alternating side by side with a plurality of structural packing or fractionating structures. The cooling portion similarly has refrigeration cores arranged alternating side by side with the structural packing or fractionating structures.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a partial sectional view of a heating structure according to the invention; and

FIG. 2 is a schematic view showing a fractional distillation process of the invention.

### DESCRIPTION OF THE PREFERRED EMBODIMENTS

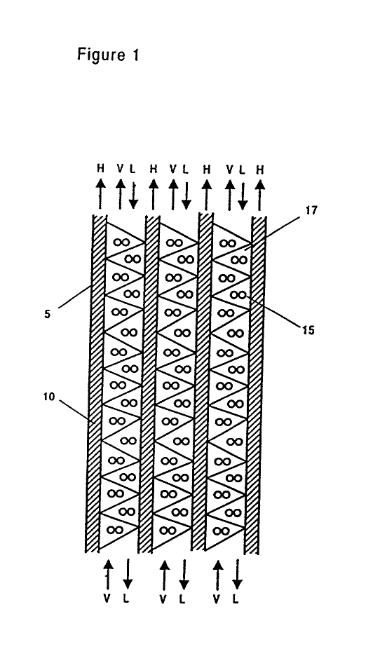

Referring now to the drawings, in which like reference numerals are used to refer to the same or similar elements, FIG. 1 shows a integrated heating structure 5 for use in a heat integrated distillation process of the invention. The heating structure 5 has heating channels 10, which are typically aligned with the distillation channels 15. However, the heating channels 10 may alternately be aligned at an angle, preferably approximately 90°, relative to distillation channels 15. The distillation channels 15 are typically filled with a structural packing or fractionating structure 17. The structural packing or fractionating structure 17 can be any of those now known to those skilled in the art.

When the heating structure 5 is used, a flowing heat source H is transmitted upwardly through the heating channels 10. Heat energy is transmitted through the channel walls to liquid L falling through the fractionating structure and vapors V rising upwardly.

The heat structure 5 may also be easily adaptable for use on the cooling side of a distillation process by forcing coolant downwardly through the channels 10 in place of the flowing heat source 20.

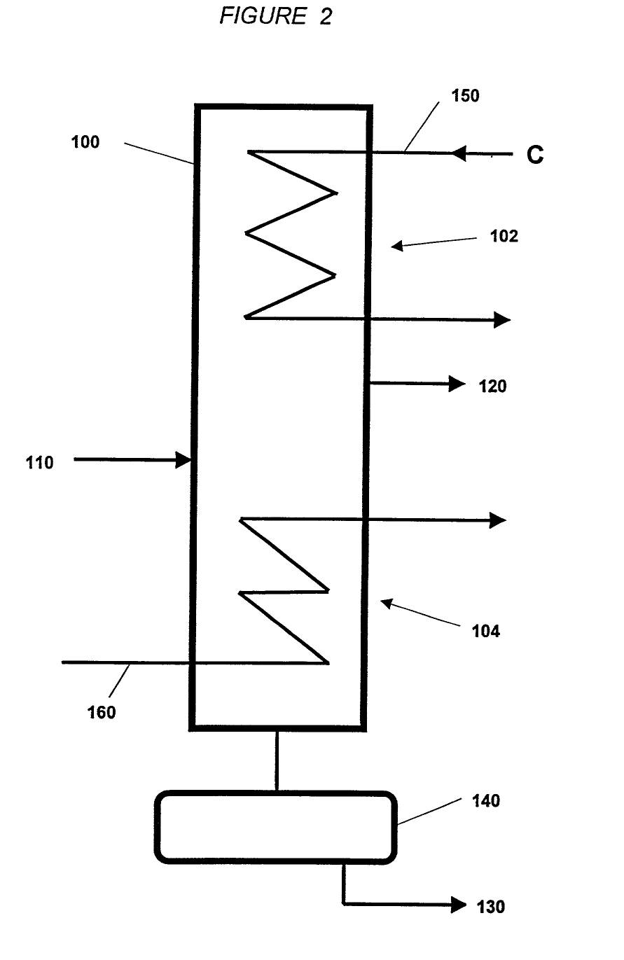

In FIG. 2, an integrated heat distillation column 100 has feed 110 supplying a product for distillation between the reflux heating 104 and cooling 102 portions of the column 100. An overhead product 120 is provided at the bottom of the cooling portion 102, while a lower product 130 is first collected in a header 140 at the bottom of the distillation column 100.

Heat 160 is provided at the bottom of the heating portion 104, while coolant 150 is provided at the top of the cooling portion 102. The heating 104 and cooling 102 portions include the heat structure 5 of FIG. 1 (adapted for cooling in the cooling portion 102) for distillation and providing reflux, respectively.

Notably, multiple heating and/or cooling means may be provided in each respective portion of column 100. For example, three separate heat structures 5 may be aligned in the heating portion 104, above one another or in the same horizontal plane. Each heat structure 5 could have different heat sources, or they may share a common source. The cooling structures could be similarly designed, with the added fact that the individual structures could use separate coolants. By way of example and not limitation, the multiple coolants could be one or more streams of propane at a specific temperature (e.g., 20° F., −20° F., etc.), other mixed refrigerant(s) which would vaporize from inlet to outlet in their respective circuit(s) within cooling portion 102, or some other process stream internal to the system.

Heat 160 can be generated by one or more reboiler heat sources, while one or more coolants 150 may be used as well. However, the foregoing are merely illustrative and in no way limiting, as those skilled in the art will readily appreciate the various applications which may be integrated with the invention.

Column 100 could be modified to permit vapor product to exit out the top end of the column (i.e., above cooling portion 102), either in addition or in place of the overhead product removal 120.

Using the heat integrated distillation column 100 uses less energy, since the heat is integrated into all theoretical stages. Thus, less fuel is used and smaller refrigeration and coolant systems may be used with the column 100. Further, the overall number of pieces of equipment required to operate the column 100 is much less than conventional distillation processes. This further results in lower maintenance costs and easier operation.

The materials used in the distillation column 100 are ideally capable of being brazed. Further, column 100 is composed of structured packing sections only in its center section (i.e., the area between heating portion 104 and cooling portion 102). This structured packing section is primarily adiabatic and not intended to be responsible for the heat exchange mechanisms present in the invention.

While a specific embodiment of the invention has been shown and described in detail to illustrate the application of the principles of the invention, it will be understood that the invention may be embodied otherwise without departing from such principles.

I claim:

1. An integrated heat distillation column, comprising:
an enclosure having an undistilled feed input;
an upper reflux cooling portion contained within the enclosure having a plurality of cooling channels arranged alternating side-by-side with a plurality of fractionating structures;
a lower heating portion contained within the enclosure having a plurality of heating channels arranged alternating side-by-side with a plurality of second fractionating structures;
cooling means for providing coolant to the plurality of cooling channels; and,
heating means for providing a fluid heating medium to the plurality of heating channels.

2. The distillation column according to claim 1, wherein the heating means comprises at least one reboiler.

3. The distillation column according to claim 1, wherein the cooling means comprises at least one cooling fluid.

4. A distillation column according to claim 1, wherein at least a portion of the fractionating structures comprise a structural packing.

5. A distillation column according to claim 4, wherein at least a portion of the fractionating structures comprise an adiabatic structural packing.

6. A distillation column according to claim 1, wherein at least a portion of the second fractionating structures comprise a structural packing.

7. A distillation column according to claim 6, wherein at least a portion of the second fractionating structures comprise an adiabatic structural packing.
